(19) United States
(12) Patent Application Publication
(10) Pub. No.: US 2022/0097328 A1
(43) Pub. Date: Mar. 31, 2022

(54) METHOD FOR MANUFACTURING TIRE

(71) Applicant: TOYO TIRE CORPORATION, Itami-shi (JP)

(72) Inventor: Shota Yoshimura, Itami-shi (JP)

(73) Assignee: TOYO TIRE CORPORATION, Itami-shi (JP)

(21) Appl. No.: 17/036,221

(22) Filed: Sep. 29, 2020

(51) Int. Cl. B29D 30/30; B60C 19/08

(52) U.S. Cl. CPC B29D 30/3028; B60C 19/08

(57) ABSTRACT

A method for manufacturing a tire includes a rubber layer forming step of helically wrapping non-conductive strip rubber supplied from an extruder around an outer circumferential side of a conductive case main body to form a plurality of rubber layers. The rubber layer forming step includes: a non-conductive strip rubber wrapping step of wrapping the non-conductive strip rubber around; and a conductive strip rubber wrapping step of superposing conductive rubber on the non-conductive strip rubber to wrap around as conductive strip rubber. The conductive strip rubber wrapping step includes: wrapping pieces of the conductive rubber around in a layered manner so as to overlap each other in a tire radial direction; and forming a conductive portion reaching up to a tire surface.

### BACKGROUND OF THE INVENTION

### Technical Field

The present invention relates to a method for manufacturing a tire.

### Related Art

Conventionally, a method for manufacturing a pneumatic tire having a structure, in which helically winding a composite rubber ribbon including two layers of conductive rubber and non-conductive rubber, is known. Pieces of the conductive rugger are partially overlapped to form a conductive path. (See, e.g., JP 2014-43138 A).

However, in the pneumatic tire obtained by the above method, the exposed area of the conductive rubber at the contact patch increases. Since the conductive rubber and the non-conductive rubber have completely different luster, improvement in appearance has been demanded by suppressing the exposed area of the conductive rubber.

### SUMMARY

The present invention has an object to provide a method for manufacturing a tire capable of providing an excellent appearance with a small exposed area of a conductive portion.

As a means for solving the above problems, the present invention provides a method for manufacturing a tire including a rubber layer forming step of helically wrapping non-conductive strip rubber supplied from an extruder around an outer circumferential side of a conductive case main body to form a plurality of rubber layers. The rubber layer forming step includes: a non-conductive strip rubber wrapping step of wrapping the non-conductive strip rubber around; and a conductive strip rubber wrapping step of superposing conductive rubber on the non-conductive strip rubber to wrap around as conductive strip rubber. The conductive strip rubber wrapping step includes: wrapping pieces of the conductive rubber around in a layered manner so as to overlap each other in a tire radial direction; and forming a conductive portion reaching up to a tire surface.

According to this method, superposing the conductive strip rubber made of the conductive rubber on the surface of the non-conductive strip rubber allows the conductive portion conductive in the tire radial direction to be formed. Since the conductive portion is exposed on the surface of the pneumatic tire only in the portion where pieces of the conductive rubber overlap in the tire radial direction, the exposed area of the conductive portion can be reduced and the appearance of the tire can be made excellent.

A step of temporarily stopping supply of the non-conductive strip rubber from the extruder between the non-conductive strip rubber wrapping step and the conductive strip rubber wrapping step may be included.

It is preferable that on the tire surface, the conductive portion is formed so as to make one round of the tire in a tire circumferential direction at one place in a tire width direction.

According to this method, it is possible to reduce the exposure of the conductive portion on the contact patch to the minimum necessary.

It is preferable that a cross-sectional shape of the non-conductive strip rubber is triangular, the conductive rubber covers the triangular bottom surface in a cross section of the non-conductive strip rubber and a region adjacent to the bottom surface, and the conductive strip rubber is wrapped around so that positions in a tire width direction of the conductive rubber are alternately displaced in each layer of the plurality of rubber layers.

According to this method, the conductive state in the tire radial direction can be made reliable while the amount of conductive rubber covering the non-conductive strip rubber is reduced.

It is preferable that the conductive portion is formed in a tread portion.

According to this method, since the conductive portion is exposed at the tread portion including the contact patch, static electricity can be surely discharged to the ground.

Before the rubber layer forming step, a base layer forming step of helically wrapping, around an outer circumferential side of the case, another conductive strip rubber covering, with conductive rubber, an entire surface of a strip-shaped non-conductive rubber having a rectangular cross section may be included.

According to this method, on the surface of the base layer, the conductive portion can be formed on the entire surface with another piece of conductive strip rubber, and on the upper layer side, the conductive portion can be formed in the tire radial direction while the tire width direction range is reduced with the conductive strip rubber.

According to the present invention, since superposing pieces of the conductive strip rubber in the tire radial direction allows the conductive portion to be formed, the exposed area of the conductive portion on the tire surface can be reduced and the appearance can be made excellent.

### BRIEF DESCRIPTION OF THE DRAWINGS

The foregoing and the other features of the present invention will become apparent from the following description and drawings of an illustrative embodiment of the invention in which:

FIG. 1 is a meridian partial sectional view of a green tire formed in an intermediate step of the method for manufacturing a pneumatic tire according to the present embodiment;

FIG. 2 is a partial cross-sectional view showing a tread ring in FIG. 1;

FIG. 3 is a schematic diagram showing a tread forming device for forming the tread ring in FIG. 2;

FIG. 4 is a schematic diagram of a first rubber feeder to be adopted in the tread forming device in FIG. 3;

FIG. 5 is a cross-sectional view of a first conductive strip rubber supplied by the first rubber feeder shown in FIG. 4;

FIG. 6 is a cross-sectional view of a non-conductive strip rubber supplied by a second rubber feeder shown in FIG. 3;

FIG. 7 is a cross-sectional view of a second conductive strip rubber supplied by the second rubber feeder shown in FIG. 3;

FIG. 8 is a meridian half sectional view of a product tire formed by the method for manufacturing a pneumatic tire according to the present embodiment;

FIG. 9 is a partial sectional view showing a tread ring according to another embodiment; and

FIG. 10 is a flowchart showing an outline of steps of the method for manufacturing a pneumatic tire according to the present embodiment.

### DETAILED DESCRIPTION OF EMBODIMENTS

Hereinafter, embodiments according to the present invention will be described with reference to the accompanying drawings. It should be noted that the following description is, fundamentally, merely exemplary and is not intended to limit the present invention, applicable objects thereof, or use thereof. In addition, the drawings are schematic, and the ratio of each dimension or the like is different from the actual one.

FIG. 1 is a meridian partial sectional view showing a tread portion of a green tire. This green tire includes a tread ring 2 on the outer circumferential side of a conductive case main body 1.

The conductive case main body 1 includes an inner liner 3, a carcass ply 4, a belt layer 5, and a belt reinforcing layer 6 from the inner side in the tire radial direction. The belt layer 5 includes a first belt 5a wrapped around the inner side in the tire radial direction and a second belt 5b wrapped around the outer circumferential surface thereof. The belt reinforcing layer 6 is wrapped around the outer circumferential surface of the second belt 5b and covers the entire belt layer 5.

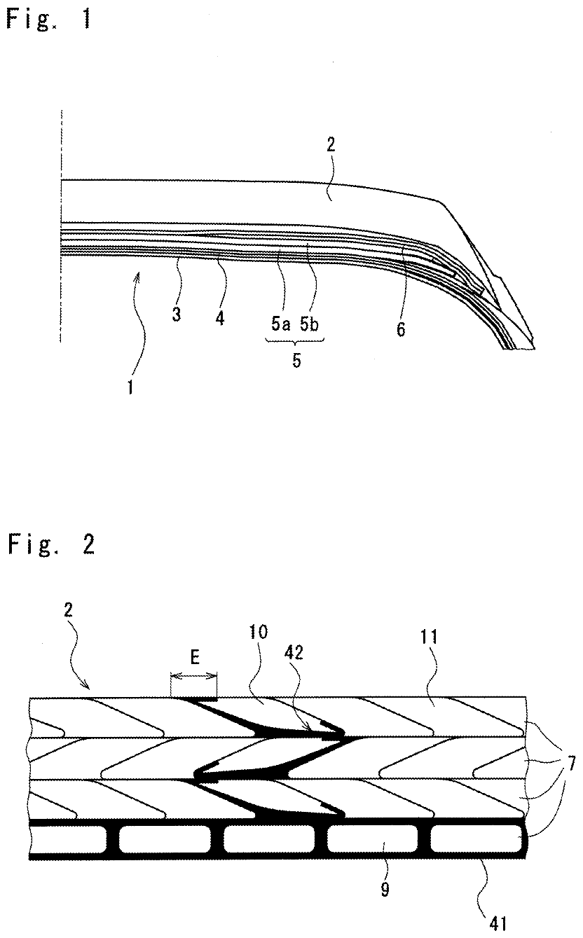

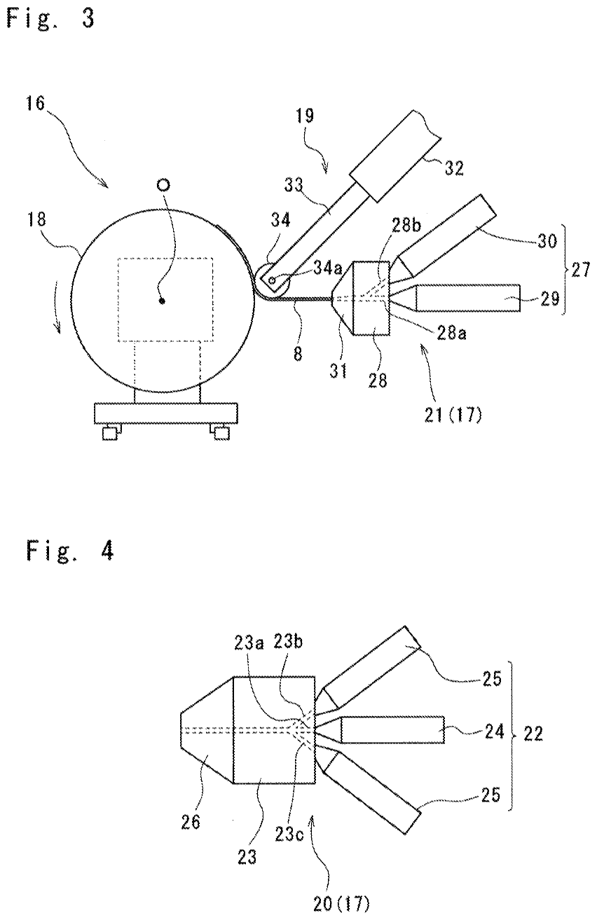

As shown in FIG. 2, the tread ring 2 includes a plurality of tread rubber layers 7. The tread rubber layer 7 is formed by helically wrapping the strip rubber 8 (See FIG. 3). In the present embodiment, the strip rubber 8 includes three types, i.e., a first conductive strip rubber 9, a second conductive strip rubber 10, and a non-conductive strip rubber 11. As described later, the first conductive strip rubber 9 is a single ribbon-shaped or strip shaped rubber continuously supplied from the first rubber supply unit 20 (see FIG. 4). On the other hand, the second conductive strip rubber 10 and the non-conductive strip rubber 11 are not separate ribbon-shaped or strip-shaped rubber. That is, as described later, the non-conductive strip rubber 11 is a single ribbon-shaped or strip-shaped (belt-shaped) rubber continuously supplied from the second rubber supply unit 20, and the non-conductive strip rubber 11 continuously supplied from the second rubber supply unit 20 (FIG. 3) is partially covered with the conductive rubber 15 supplied from the second conductive rubber feeder 30, which is included in the second rubber supply unit 20, at an appropriate timing. In the non-conductive strip rubber 11, the part partially covered with the conductive rubber 15 is the second conductive strip rubber 10.

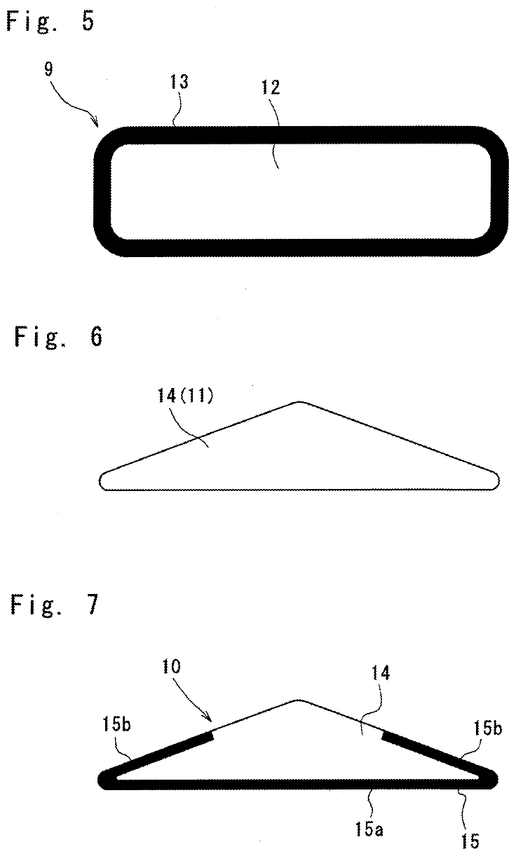

As shown in FIG. 5, the first conductive strip rubber 9 has a configuration in which the periphery of a strip-shaped first rubber 12 (non-conductive rubber) having a rectangular cross section is covered with a first conductive rubber 13. The first conductive strip rubber 9 is used to form a base layer 41 of the tread rubber layer 7.

As shown in FIG. 7, the second conductive strip rubber 10 has a configuration in which a bottom surface of a strip-shaped second rubber 14 (non-conductive rubber) having a triangular cross section and a region adjacent to the bottom surface is covered with a second conductive rubber 15. The second conductive rubber 15 includes a first covering portion 15a that covers the entire bottom surface of the second rubber 14, and second covering portions 15b each of which is continuous with the first covering portion 15a and which respectively cover part of slopes extending obliquely upward in a direction approaching from both edges of the bottom surface. Each of the second covering portion 15b is formed in the range from the lower edge to the half or more in the entire range from the lower edge of each of the slopes toward the upper edge where the slopes intersect. The second conductive strip rubber 10 is wrapped around the first conductive strip rubber 9 forming the base layer 41 so as to overlap in the tire radial direction, and forms the conductive portion 42 in an upper layer portion (layer in the tread rubber layer 7 excluding the base layer 41 formed by the first conductive strip rubber 9).

As shown in FIG. 6, the non-conductive strip rubber 11 is consist of only the second rubber 14 (non-conductive rubber). The non-conductive strip rubber 11 is helically wrapped around the first conductive strip rubber 9 forming the base layer 41 so as to overlap in the tire radial direction, and forms a portion other than the conductive portion 42 in the upper layer portion.

In a green tire, the tread rubber layer 7 is formed in the outer circumferential portion of the conductive case main body 1 by a tread forming device 16 shown in FIG. 3. The tread forming device 16 includes a rubber supply member 17, a drum 18, a pressure bonding member 19, and the like.

The rubber supply member 17 includes a first rubber supply unit 20 for supplying the first conductive strip rubber 9 as well as a second rubber supply unit 21 for supplying the second conductive strip rubber 10 and the non-conductive strip rubber 11.

As shown in FIG. 4, the first rubber supply unit 20 includes three first extruders 22 and one first die 23. Of the three first extruders 22, one unit is a first rubber feeder 24 that supplies rubber in a strip shape. The remaining two units are first conductive material feeders 25 which are respectively arranged above and below the first rubber feeder 24 and each of which supply the conductive rubber in a strip shape.

Formed in the first die 23 are a first passage 23a for guiding the rubber supplied from the first rubber feeder 24, and a second passage 23b and a third passage 23C for guiding the conductive rubber supplied from the respective first conductive rubber feeders 25. Each passage has a rectangular cross section. The second passage 23b merges with the first passage 23a from an upper side thereof, and the third passage 23c merges with the first passage 23a from the lower side. A first mouthpiece 26 is provided at a downstream side of a portion where the first passage 23a, the second passage 23b, and the third passage 23C merge with each other.

The first rubber 12 continuously supplied from the first rubber feeder 24 has a rectangular cross section when passing through the first passage 23a. Then, the conductive rubber continuously supplied from each of first conductive rubber feeder 25 passes through the second passage 23b and the third passage 23C, and sandwiches from above and below the first rubber 12 to be united with first rubber 12 having a rectangular-cross-section shape due to being supplied to the first passage 23a. Then, from the first mouthpiece 26, one first conductive strip rubber 9 (see FIG. 5) having a two-layer structure including the first rubber 12 on the inner side and the first conductive rubber 13 that covers all the four peripheral surfaces continuously flows out.

As shown in FIG. 3, the second rubber supply unit 21 includes two second extruders 27 and one second die 28. One of the second extruders 27 is a second rubber feeder 29 that continuously supplies rubber in a strip shape. The other of the second extruder 27s is a second conductive rubber feeder 30 which is arranged on the upper side of the second rubber feeder 29 and which can continuously supply the conductive rubber in a strip shape.

In the second die 28, a first passage 28a for guiding the second rubber 14 supplied from the second rubber feeder 29, and a second passage 28b for guiding the conductive rubber 15 supplied from the second conductive rubber feeder 30 are formed. The first passage 28a has a triangular cross section. The second rubber 14 supplied from the second rubber feeder 29 has a triangular cross section when passing through the first passage. The second passage 28b merges with the first passage 28b from the upper side. A second mouthpiece 31 is provided at the end of the portion where the first passage 28a and the second passage 28b merge.

The second rubber 14 supplied from the second rubber feeder 29 has a triangular cross section when passing through the first passage 28a of the die. Then, when the conductive rubber 15 is not supplied from the second conductive rubber feeder 30, the non-conductive strip rubber 11 flows out through the second mouthpiece 31 as it is. On the other hand, when the conductive rubber 15 is supplied from the second conductive rubber feeder 30, the supplied conductive rubber passes through the second passage 28b and merges with the first passage 28A, thereby covering the bottom surface and its adjacent region of the second rubber 14. Then, a second conductive strip rubber 10 having a two-layer structure including the second rubber 14 and the second conductive rubber 15 that covers the bottom surface and its adjacent region of the second rubber 14 flows out from the second mouthpiece 31.

Thus, depending on whether the conductive rubber is supplied from the second conductive rubber feeder 30, the second rubber supply unit 21 can switch to and provide any of the non-conductive strip rubber 11 and the second conductive strip rubber 10. That is, in the second rubber supply unit 21, the second rubber 14 is continuously supplied from the second rubber feeder 29, and the conductive rubber 15 is supplied from the second conductive rubber feeder 30 at an appropriate timing. When the second rubber 14 is supplied from the second rubber feeder 29, but the conductive rubber 15 is not supplied from the second conductive rubber feeder 30, the non-conductive strip rubber 11 flows out from the second rubber supply unit 21. On the other hand, when the conductive rubber 15 is supplied from the second conductive rubber feeder 30 while the second rubber 14 is supplied from the second rubber feeder 29, the second conductive strip rubber 10 flows out from the second rubber supply unit 21 at a timing corresponding to that of the supply of the conductive rubber 15 from the second conductive rubber feeder 30.

It should be noted that here, for the rubber supplied by the rubber supply member 17, a rubber material having a volume resistivity of 108Ω or more, such as those obtained by mixing a raw rubber with silica as a reinforcing material at a high ratio, is used. In addition, for the conductive rubber, a rubber material having a volume resistivity of less than 108Ω, such as those obtained by mixing a raw rubber with carbon black as a reinforcing material at a high ratio, is used.

The drum 18 is formed in a cylindrical shape centered on the axis O. The outer circumferential surface of the drum 18 includes a metal segment that can be expanded and contracted in the radial direction, a bladder, or the like. In addition, the drum 18 rotates counterclockwise in FIG. 3 about the axis O by driving means such as a motor (not shown). Furthermore, the drum 18 reciprocates in the direction along the axis O by driving means such as a motor (not shown).

The pressure bonding member 19 includes a cylindrical pressure roller attached to and rotatable about a rotating shaft 34a at a tip end of a piston rod 33 that can be moved back and forth by a cylinder 32. The pressure roller 34 is arranged so that the axial direction of the rotating shaft 34a thereof is parallel to the axial direction of the drum 18. Driving the cylinder 32 and moving the piston rod 33 forward allows the strip rubber 8 supplied from the rubber supply unit to be pressed against and bonded to the outer circumferential surface of the conductive case main body 1 with the outer circumferential surface of the pressure roller 34.

Next, a method of forming the tread rubber layer 7 on the outer circumferential surface of the conductive case main body 1 with the tread forming device 16 having the above-described configuration will be described.

Referring to FIG. 10, this method includes a base layer forming step and a rubber layer forming step. In the base layer forming step, the first rubber supply unit 20 helically wraps the first conductive strip rubber 9 around the outer circumferential side of the conductive case main body 1 to form the base layer 41. When the base layer forming step is completed, the machine is temporarily stopped and the supply of the strip rubber is switched from the first rubber supply unit 20 to the second rubber supply unit 21. In the rubber layer forming step, the non-conductive strip rubber 11 supplied from the second rubber feeder 25 is wrapped around the outside of the base layer 41, and the second conductive rubber 15 is supplied from the second conductive rubber feeder 30 at appropriate timings so as to be superposed on the non-conductive strip rubber 11. That is, the rubber layer forming step includes a non-conductive strip rubber wrapping step of wrapping the non-conductive strip rubber 11 as it is without being covered, and a conductive strip rubber wrapping step of superposing the conductive rubber 15 on the non-conductive strip rubber 11 to wrap as the second conductive strip rubber 10. Hereinafter, the base layer forming step and the rubber layer forming step will be described more specifically.

(Base Layer Forming Step)

The conductive case main body 1 formed in another step is arranged on the outer circumference of the drum 18. The drum 18 is expanded in diameter to hold the conductive case main body 1, and driving a motor (not shown) starts the rotation of the drum 18.

The first rubber supply unit 20 is driven to supply the first conductive strip rubber 9 to the rotating drum 18. The supplied first conductive strip rubber 9 is pressed against the outer circumferential surface of the conductive case main body 1 by the pressure bonding member 19. The drum 18 is moved in the axial direction while being rotated. The feed ratio of the drum 18 at this time is set so that pieces of the first conductive strip rubber 9 do not overlap each other and are arranged without a gap. Thus, the first conductive strip rubber 9 is evenly helically wrapped around at a uniform height, which forms a base layer 41 that covers the belt reinforcing layer 6.

The formed base layer 41 is obtained by wrapping the first conductive strip rubber 9 whose periphery is formed of the first conductive rubber 13. Therefore, the front and back surfaces are in a conductive state. In addition, a metal cord is used for the belt reinforcing layer 6, the belt layer 5, and the carcass ply 4 covered with the base layer 41. Although not shown, the carcass ply 4 is connected to a head core (not shown) made of a bundle of metal cords. Therefore, when the tire in a state of a product tire is assembled to the rim, the rim is electrically connected to the surface of the base layer 41 through the bead core, the carcass ply 4, the belt layer 5, and the belt reinforcing layer 6.

(Rubber Layer Forming Step)

Subsequently, the drive of the first rubber supply unit 20 is stopped and the drive of the second rubber supply unit 21 is started. In the second rubber supply unit 21, the second rubber 14 is supplied from the second rubber feeder 29. However, the supply of the conductive rubber from the second conductive rubber feeder 30 is not started. Thus, the non-conductive strip rubber 11 is supplied to the rotating drum 18. The supplied non-conductive strip rubber 11 is pressed against the outer circumferential surface at one end side of the base layer 41 by the pressure bonding member 19. The drum 18 is moved in the axial direction while being rotated, and the non-conductive strip rubber 11 is helically wrapped around toward the other end side of the base layer 41 (non-conductive strip rubber wrapping step). At this time, the feed ratio of the drum 18 is set so that pieces of the non-conductive strip rubber 11 overlap each other half.

When the non-conductive strip rubber 11 is wrapped around up to a central portion of the base layer 41 in the axial direction of the drum 18, the supply of the conductive rubber is started from the second conductive rubber feeder 30. Specifically, first, the supply of the second rubber 14 from the second rubber feeder 29 is temporarily stopped, and after that, the conductive rubber is supplied from the second conductive rubber feeder 30 while the second rubber 14 is supplied from the second rubber feeder 29. Supplying the conductive rubber from the second conductive rubber feeder 30 causes the strip rubber 8 that is to be wrapped around the base layer 41 to become the second conductive strip rubber 10 (conductive strip rubber wrapping step). Then, when the second conductive strip rubber 10 is wrapped around by one round, the supply of the second rubber 14 from the second rubber feeder 29 is temporarily stopped and the supply of the conductive rubber from the second conductive rubber feeder 30 is stopped, and thereafter, the supply of the second rubber 14 from the second rubber feeder 29 is restarted, and the strip rubber 8 to be supplied is switched to the non-conductive strip rubber 11. Thereafter, when the non-conductive strip rubber 11 is wrapped around up to the other end of the base layer 41 in the axial direction of the drum 18, the moving direction of the drum 18 is converted into the opposite direction, and the non-conductive strip rubber 11 is wrapped around from the other end toward the one end side of the base layer 41. Then, when the non-conductive strip rubber 11 is wrapped around up to the central portion, in the same manner as described above, the non-conductive strip rubber 11 is switched to the second conductive strip rubber 10 and wrapped around by one round. At this time, the second conductive strip rubber 10 wrapped around earlier and the second conductive strip rubber 10 to be wrapped around next overlap each other, and pieces of the second conductive rubber 15 are brought into contact with each other to be conductive.

Hereinafter, similarly, the non-conductive strip rubber 11 and the second conductive strip rubber 10 are wrapped around to complete the tread ring 2 including a plurality of tread rubber layers 7.

In the tread rubber layer 7 thus obtained, the conductive portion 42 in which pieces of the second conductive strip rubber 10 overlap each other in the tire radial direction is formed only in the central portion in the width direction. The second conductive strip rubber 10 has a configuration of including the second conductive rubber 15 only on the bottom surface of the strip-shaped second rubber 14 and in the region adjacent thereto. Therefore, the conductive portion 42 exposed on the surface of the tread rubber layer 7 (shown as an exposed portion “E” in FIG. 2) is only the one second covering portion 15b of the second conductive rubber 15, the second covering portion 15b exposed only at one place of the central portion in the tire width direction, and is reduced in exposed area to be excellent in appearance. It should be noted that the exposed portion “E” is provided so as to go around the surface of the tread rubber layer 7 in the tire circumferential direction.

In addition, the single second rubber supply unit 21 can conduct wrapping the second rubber 14 around as the non-conductive strip rubber 11 as it stands, and combining the second rubber 14 with the conductive rubber and wrapping the combined one around as the second conductive strip rubber 10. Therefore, the equipment can be simplified and the conductive portion 42 can be formed at low cost.

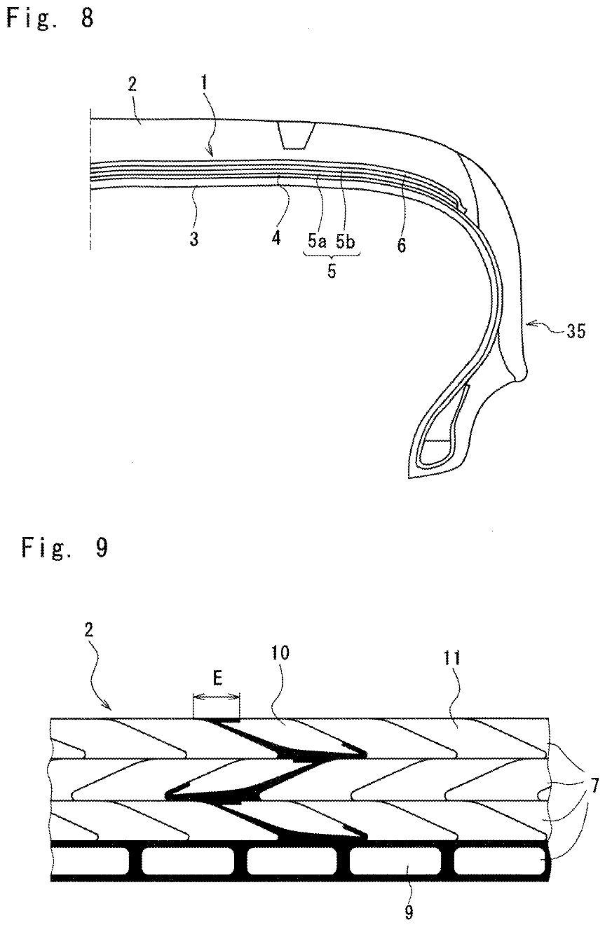

It should be noted that after the tread rubber layer 7 is formed on the outer circumferential surface of the conductive case main body 1, wrapping a sidewall rubber around the side portion 35 completes a green tire. The completed green tire is vulcanized by a vulcanization molding machine to be a product tire shown in the meridian half sectional view in FIG. 8.

### Other Embodiments

The present invention is not limited to the configuration described in the above embodiment, and various modifications are possible.

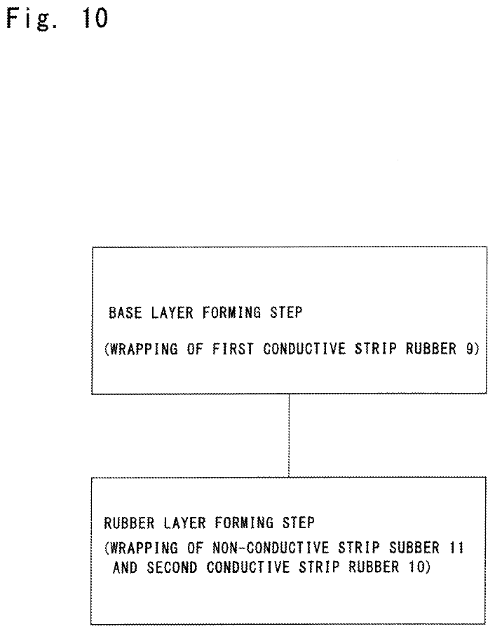

In the above-described embodiment, wrapping the second conductive strip rubber 10 around so as to overlap in a row in the tire radial direction forms the conductive portion 42, but the conductive portion 42 can be formed as shown in FIG. 9. Around the earlier-wrapped second conductive strip rubber 10 (first wrapping portion), the second conductive strip rubber 10 to be wrapped around next (second wrapping portion) is wrapped so as to shift its position by a half pitch in the tire width direction. Furthermore, the second conductive strip rubber 10 to be wrapped around next (third wrapping portion) is wrapped so as to shift its position by a half pitch on the side opposite to that of the second wrapping portion. That is, the second conductive strip rubber 10 is wrapped around so as to be in two zigzag rows.

This makes it easier to bring the bottom surface of the second conductive strip rubber 10 to be wrapped around next into close contact with the second conductive rubber 15 in the adjacent region of the second conductive strip rubber 10 wrapped around earlier. In other words, the conductive state between the second conductive strip rubber 10 on the base layer 41 side and the second conductive strip rubber 10 on the surface layer side can be made satisfactory.

In the above embodiment, wrapping the pieces of second conductive strip rubber 10 around so as to overlap each other in the tire radial direction at the central portion in the tire width direction forms the conductive portion 42, but the conductive portion can be optionally formed at any position in the tire width direction.

What is claimed is:

1. A method for manufacturing a tire comprising a rubber layer forming step of helically wrapping non-conductive strip rubber supplied from an extruder around an outer circumferential side of a conductive case main body to form a plurality of rubber layers, wherein
the rubber layer forming step includes:
a non-conductive strip rubber wrapping step of wrapping the non-conductive strip rubber around; and
a conductive strip rubber wrapping step of superposing conductive rubber on the non-conductive strip rubber to wrap around as conductive strip rubber, and
the conductive strip rubber wrapping step includes:
wrapping pieces of the conductive rubber around in a layered manner so as to overlap each other in a tire radial direction; and
forming a conductive portion reaching up to a tire surface.

2. The method for manufacturing a tire according to claim 1, further comprising a step of temporarily stopping supply of the non-conductive strip rubber from the extruder between the non-conductive strip rubber wrapping step and the conductive strip rubber wrapping step.

3. The method for manufacturing a tire according to claim 1, wherein on the tire surface, the conductive portion is formed so as to make one round of the tire in a tire circumferential direction at one place in a tire width direction.

4. The method for manufacturing a tire according to claim 2, wherein on the tire surface, the conductive portion is formed so as to make one round of the tire in a tire circumferential direction at one place in a tire width direction.

5. The method for manufacturing a tire according to claim 1, wherein
a cross-sectional shape of the non-conductive strip rubber is triangular,
the conductive rubber covers the triangular bottom surface in a cross section of the non-conductive strip rubber and a region adjacent to the bottom surface, and
the conductive strip rubber is wrapped around so that positions in a tire width direction of the conductive rubber are alternately displaced in each layer of the plurality of rubber layers.

6. The method for manufacturing a tire according to claim 2, wherein
a cross-sectional shape of the non-conductive strip rubber is triangular,
the conductive rubber covers the triangular bottom surface in a cross section of the non-conductive strip rubber and a region adjacent to the bottom surface, and
the conductive strip rubber is wrapped around so that positions in a tire width direction of the conductive rubber are alternately displaced in each layer of the plurality of rubber layers.

7. The method for manufacturing a tire according to claim 3, wherein
a cross-sectional shape of the non-conductive strip rubber is triangular,
the conductive rubber covers the triangular bottom surface in a cross section of the non-conductive strip rubber and a region adjacent to the bottom surface, and
the conductive strip rubber is wrapped around so that positions in a tire width direction of the conductive rubber are alternately displaced in each layer of the plurality of rubber layers.

8. The method for manufacturing a tire according to claim 1, wherein the conductive portion is formed in a tread portion.

9. The method for manufacturing a tire according to claim 2, wherein the conductive portion is formed in a tread portion.

10. The method for manufacturing a tire according to claim 3, wherein the conductive portion is formed in a tread portion.

11. The method for manufacturing a tire according to claim 5, wherein the conductive portion is formed in a tread portion.

12. The method for manufacturing a tire according to claim 1, further comprising, before the rubber layer forming step, a base layer forming step of helically wrapping another conductive strip rubber around an outer circumferential side of the case, wherein
said another conductive strip rubber includes a strip-shaped non-conductive rubber having a rectangular cross section, and an entire surface of a strip-shaped non-conductive rubber is covered with conductive rubber.

13. The method for manufacturing a tire according to claim 2, further comprising, before the rubber layer forming step, a base layer forming step of helically wrapping another conductive strip rubber around an outer circumferential side of the case, wherein
said another conductive strip rubber includes a strip-shaped non-conductive rubber having a rectangular cross section, and an entire surface of a strip-shaped non-conductive rubber is covered with conductive rubber.

14. The method for manufacturing a tire according to claim 3, further comprising, before the rubber layer forming step, a base layer forming step of helically wrapping another conductive strip rubber around an outer circumferential side of the case, wherein
said another conductive strip rubber includes a strip-shaped non-conductive rubber having a rectangular cross section, and an entire surface of a strip-shaped non-conductive rubber is covered with conductive rubber.

15. The method for manufacturing a tire according to claim 5, further comprising, before the rubber layer forming step, a base layer forming step of helically wrapping another conductive strip rubber around an outer circumferential side of the case, wherein
said another conductive strip rubber includes a strip-shaped non-conductive rubber having a rectangular cross section, and an entire surface of a strip-shaped non-conductive rubber is covered with conductive rubber.

16. The method for manufacturing a tire according to claim 8, further comprising, before the rubber layer forming step, a base layer forming step of helically wrapping another conductive strip rubber around an outer circumferential side of the case, wherein
said another conductive strip rubber includes a strip-shaped non-conductive rubber having a rectangular cross section, and an entire surface of a strip-shaped non-conductive rubber is covered with conductive rubber.
